(19) United States
(12) Patent Application Publication
(10) Pub. No.: US 2005/0164681 A1
(43) Pub. Date: Jul. 28, 2005

(54) Voice message storage in a push-to-talk communication system

(76) Inventors: William Wesley Jenkins, Wheaton, IL (US); Robin Greg Kim, Naperville, IL (US); Laurel Ann Salvador, Wheaton, IL (US); Jeffrey Scott Fischman, Naperville, IL (US)

Correspondence Address: PATTI & BRILL, ONE NORTH LASALLE STREET, 44TH FLOOR, CHICAGO, IL, 60602, US

(21) Appl. No.: 10/762,615

(22) Filed: Jan. 22, 2004

(51) Int. Cl. H04M 11/10; H04M 1/64

(52) U.S. Cl. 455/412.1; 379/88.17; 379/88.22

(57) ABSTRACT

A method permits an originating PTT subscriber to be able to elect to transmit a voice message that will be stored by the PTT system for a later delivery to the designated recipient. A communication application server receives the voice message via packets and upon recognizing a predetermined code stores the voice message for later delivery to the designated recipient. The server then transmits a status update message to the mobile terminals of the originating subscriber and the designated recipient causing the respective status of each to be modified with indicia indicating that a voice message from the originating subscriber awaits delivery to the designated recipient. Upon the election of the designated recipient, the stored voice message from the originating subscriber is requested to be played.

### BACKGROUND

This invention relates generally to push-to-talk (PTT) voice communication systems, and more specifically relates to an improved capability of such a system that allows an originating subscriber to transmit a voice message designated for later delivery to a destination subscriber.

Push-to-talk communication systems, such as the Nextel wireless communications system in the United States, are known. Subscribers of such systems utilize a wireless mobile terminal (MT) that includes a push-to-talk button and a display that lists the names of other subscribers on a Pal list such as shown in FIG. 5. Voice communications proceed in a half-duplex mode in which only one subscriber talks, i.e. transmits, at one time while holding down the PTT button. The recipient of the voice communication is determined by the originating subscriber selecting the recipient from among a list of Pals shown on the screen of the originating subscriber's mobile terminal. It is also possible for the originating subscriber to transmit the voice communication simultaneously to a plurality of other subscribers by selecting a group Pal icon that defines a plurality of individual subscribers to receive the communication.

Initiating a voice communication by depressing the PTT button while inputting a spoken message causes a series of packets containing the spoken message addressed to the recipient for delivery through a server. The system, i.e. the server, attempts to deliver these packets to the indicated recipient's mobile terminal. The packets containing the spoken message may be temporarily stored in the system for a short time, e.g. several seconds, as part of the normal delivery cycle processing. If the recipient's mobile terminal receives the packets, the voice message contained by the packets is decoded and output over the speaker of the mobile terminal. If the recipient's mobile terminal is not available to receive the voice communication, or for whatever reason does not receive the voice communication, the packets containing the spoken message are discarded by the system following the delivery or attempted delivery. Thus, regardless of whether delivery was successful or not, the packets containing the voice message are discarded following the delivery process.

Conventional telephony systems provide a variety of choices for subscribers to obtain delayed voice messages. For example, a subscriber may utilize an answering machine as part of the customer's premise equipment to store a voice message from a calling party. Alternatively a customer may subscribe to a voicemail system supported by the central office equipment of the local exchange carrier. Sophisticated automated call distribution systems provide a variety of options for storing and playing out voice messages. Conventional cellular wireless systems commonly offer wireless subscribers the ability to subscribe to voicemail as part of the wireless services offered. The cellular voicemail services are substantially identical to the landline voicemail systems in terms of operation with the primary difference being that the voicemail system is accessed from a cellular telephone.

Some mobile terminals are capable of operation in a cellular mode and a PTT mode. However, such mobile terminals cannot simultaneously operate in both modes, and hence a subscriber using a PTT mode of communications cannot retrieve voicemail services made available to cellular users without leaving the PTT mode and switching the terminal for operation in the cellular mode. Thus, from the user's viewpoint having such a dual mode device is like having two independent communication devices in which the functions available from one service may not be available from the other service. Further, a user will likely want to communicate with people who subscribe to only one of the PTT and cellular services, and hence the user of a dual mode terminal cannot use features available on one service when the destination subscriber only is available through the other service.

Because PTT wireless systems evolved to provide relatively short, half duplex voice communications that quickly reached the destination subscriber, the PTT systems were not designed to support voicemail or a capability for an originating subscriber to be able to control a delayed delivery of a voice message. Because subscribers of PTT systems are accustomed to using features offered by landline and cellular systems, there exists a need to provide PTT subscribers with a delayed voice message delivery capability in order to satisfy the PTT subscriber's need for enhanced communication flexibility.

### SUMMARY OF THE INVENTION

It is an object of the present invention to provide a technological solution that will satisfy this need.

In accordance with an embodiment of the present invention, an originating PTT subscriber is provided with the ability to elect to transmit a voice message that will be stored by the PTT system for a later delivery to the designated recipient. The originating subscriber's mobile terminal utilizes a predetermined code transmitted with packets containing the voice message that signifies that the voice message is to be held in storage for later delivery as opposed to being immediately routed for attempted delivery to the designated recipient. A communication application server receives the packets and upon recognizing the predetermined code stores the voice message for later delivery to the designated recipient. The server then transmits a status update message to the mobile terminals of the originating subscriber and the designated recipient causing the respective status of each to be modified with indicia indicating that a voice message from the originating subscriber awaits delivery to the designated recipient. Upon the election of the designated recipient, the stored voice message from the originating subscriber can be requested to be played to the recipient. Preferably, after the voice message has been played to the recipient, the status indicia at both the originating subscriber and the designated recipient indicating a waiting voice message for delivery is modified to indicate that the voice message is no longer awaiting delivery.

### BRIEF DESCRIPTION OF THE DRAWINGS

FIG. 1 is a block diagram of a wireless push-to-talk communication system suited for incorporating an embodiment of the present invention.

FIG. 2 is a functional block diagram of a PTT mobile terminal in accordance with an embodiment of the present invention.

FIG. 3 is a block diagram of the communication application server as shown in FIG. 1.

FIG. 4 is a block diagram illustrating an exemplary architecture for each of the elements shown in FIG. 3.

FIG. 5 is an example of a prior art display of a PTT mobile terminal.

FIG. 6 is a flow diagram illustrating steps by an originating mobile terminal of a voice message for later delivery in accordance with an exemplary method of the present invention.

FIG. 7 is an example of a display of a PTT mobile terminal of an originating subscriber after a voice message has been transmitted for later delivery to a recipient in accordance with an embodiment of the present invention.

FIG. 8 is a flow diagram illustrating steps taken by the communication application server in accepting a voice message for later delivery in accordance with an exemplary method of the present invention.

FIG. 9 is an example of a display of a PTT mobile terminal of a destination subscriber indicating that a voice message awaits delivery from the originating subscriber in accordance with an embodiment of the present invention.

FIG. 10 is a flow diagram illustrating steps by a recipient mobile terminal in retrieving a stored voice message in accordance with an exemplary method of the present invention.

FIG. 11 is a flow diagram illustrating steps taken by the communication application server in delivering a stored voice message in accordance with an exemplary method of the present invention.

### DETAILED DESCRIPTION

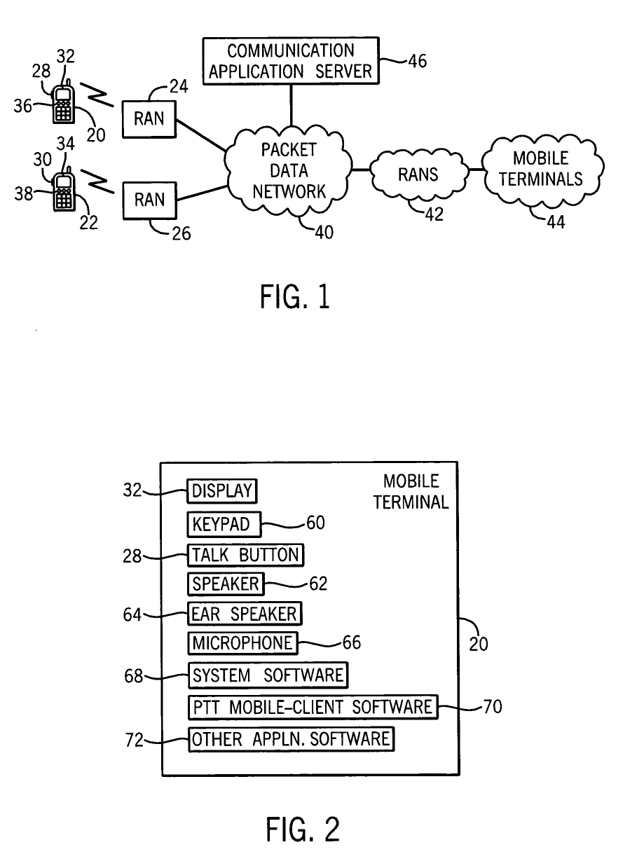

FIG. 1 is a block diagram of a PTT wireless communications system in which exemplary PTT mobile terminals 20 and 22 have wireless communications supported by radio access nodes (RAN) 24 and 26, respectively. The mobile terminals 20 and 22 have PTT buttons 28 and 30, respectively, that are depressed by the user during a voice transmission. The mobile terminals communicate information such as voice to and from the respective user by receiving and transmitting packets over a radio frequency communication link where the payload of the packets carries the user's information. The mobile terminals 20 and 22 have visual displays 32 and 34, respectively. The displayed information such as words and symbols assists the user in initiating and receiving communications as well as controlling functions of the mobile terminal. Control buttons 36 and 38 are contained on the respective mobile terminals. The control buttons will typically include a touchtone dialing keypad and other buttons associated with various control functions that may either be dedicated to a specific function or provide control input for a variety of functions that may be defmed by indicia shown on the display. As used herein, a PTT mobile terminal refers to a wireless communication device operating in a push-to-talk mode, and a PTT wireless communication system refers to a wireless communication system using a half-duplex mode of communications such as supported by PTT mobile terminals.

A packet data network 40 receives packets and determines the appropriate destination routing based on the packet's address. The packet data network, an addition to supporting communications with RAN's 24 and 26, supports communications with a variety of RAN's 42 that in turn supports a variety of mobile terminals 44. The packet data network also supports the communication of packets with the communication application server 46. As will be explained in detail below, the communication application server 46 supports a delayed message function in accordance with an embodiment of the present invention.

FIG. 2 is a functional block diagram of exemplary mobile terminal 20. The display 32 and PTT button 28 have been previously described above. A keypad 60 typically includes a touchtone dialing set of buttons and other function related buttons such as directional control and function selection capabilities associated with indicia shown on the display. A speaker 62 converts electronically encoded audio information into sound pressure levels (sound). The ear speaker 64 provides the same function as speaker 62 except that it is typically a small unit worn in or about the ear and produces lower volume sounds intended only for the user wearing the ear speaker. Microphone 66 typically comprises a microphone built-in as part of the mobile terminal that accepts sounds, i.e. user speech, and converts the sounds into electronic signals.

System software 68 consists of basic operational software associated with functions provided by the mobile terminal and may include general input/output control such as operation and control of the keypad, buttons, and display, the control of the transmitter and receiver functions, general operating system functions including microprocessor and memory control, and provide an interface between the local audio and visual inputs/outputs and the communication protocols required for receiving and transmitting packets. The PTT mobile-client software 70 provides additional functionality in accordance with an embodiment of the present invention as will be described in detail below. The other application software 72 may comprise other additional software that provides different functionality for the mobile terminal. For example, the mobile terminal may function in two separate and independent communication modes, e.g. a PTT communication mode and a conventional cellular telephone communication mode, where the PTT communication mode is supported by the system software 68 and the PTT mobile-client software 70, and the cellular telephone communication mode is supported by the system software 68 in combination with the other application software 72.

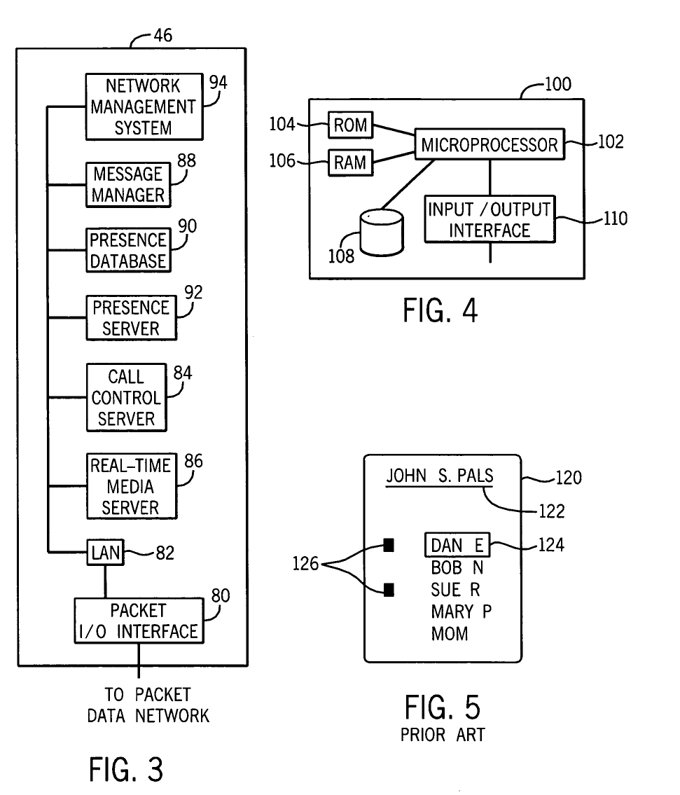

FIG. 3 is a block diagram of the communication application server 46. A packet input/output interface 80 in combination with a local area network (LAN) 82 provides connectivity among the elements within communication application server 46 and the packet data network 40. Call control server 84 functions as the primary server for call processing. The real-time media server 86 provides temporary voice path buffering to assist in providing a consistent stream of packets to minimize undesired voice path interruptions and also functions as a packet duplicator to supply streams of duplicate packets to multiple terminating legs of a group call. The message manager 88 provides longer-term, e.g. days/weeks, storage of information received by packets from a user and is used in accordance with an embodiment of the present invention to store voice messages intended for later delivery. The presence database 90 stores data related to each PTT subscriber including the state or status of the subscriber's mobile terminal and other information related to services subscribed to by the user. The presence server 92 is a “front-end” server for presence database 90 that collects and distributes state updates. Preferably, the presence server provides users with access via the Internet to permit management of Pal lists. The network management system 94 functions as a maintenance server that performs system operations, administration and management functions.

FIG. 4 illustrates an exemplary architecture 100 utilized for each of the elements of the communication application server 46. A microprocessor 102 is supported by read-only memory (ROM) 104, random access memory (RAM) 106 and a nonvolatile memory storage element 108. An input/output interface 110 facilitates communications between the microprocessor 102 and external devices. An operating system, application software and system data are stored in memory and provide operating control instructions for microprocessor 102.

FIG. 5 illustrates an exemplary screen display 120 as known in the prior art of a mobile terminal. In this example, “John S.” is the user of the mobile terminal with screen display 120 showing at least a partial listing of Pals as indicated by the title 122. The shown list of five Pals can be scrolled using function keys on the mobile terminal to show additional people and/or groups on the Pal list. As shown, the Pal “Dan E.” is highlighted at 124 indicating the selection of this Pal for further action or instructions by the user such as by placing a call to the selected Pal. The displayed visual indicia 126 associated with Dan E. and Sue R. indicates that each of these Pals is currently logged in the communication system and is potentially available for communications.

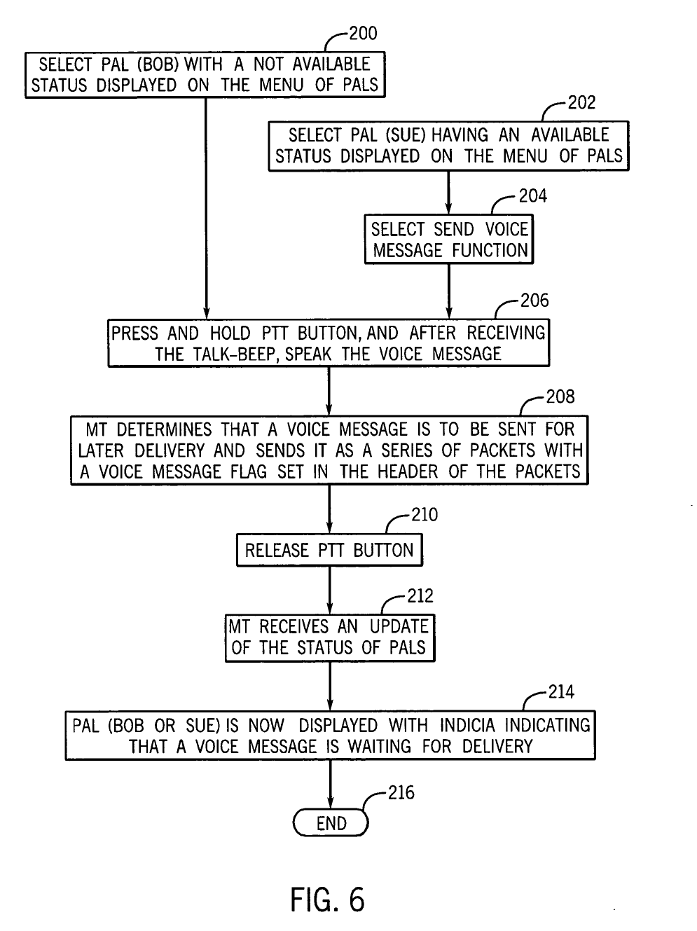

FIG. 6 is a flow diagram in accordance with an embodiment of the present invention illustrating steps carried out by an originating mobile terminal upon a user's election to transmit a voice message for later delivery to a selected Pal. In step 200 an originating user John S. selects the Pal Bob N. to receive a communication by causing Bob's name to become highlighted. The lack of a “present” indicia (or inclusion of a “not-present” indicia) associated with Bob indicates that Bob is not currently available to receive a cormnunication. An alternative way of initiating a voice message for later delivery is indicated by steps 202 and 204. In step 202 originating user John S. selects the Pal Sue R. who has an available status as indicated by the status indicia associated with Sue. In step 204 user John selects a send voice message function such as by pressing a button associated with this function or by proceeding to a further submenu having this function as a possible selection. In step 206 user John presses and holds the PTT button, and after receiving a talk-beep indicating he has the floor to transmit, speaks a voice message intended for the selected Pal (Bob if step 200 was taken and Sue if steps 202 and 204 were taken). The originating mobile terminal is alerted that a voice message for later delivery is desired by: (a) the selection of a Pal that is not available as shown by the status indicia and attempted communication via pressing the PTT button; or (b) selecting a Pal that is available as shown by the status indicia and (i) specifically selecting a send voice message function, or (ii) electing to again press the PTT button within a predetermined time period following an unsuccessful attempt to transmit a normal real-time voice communication to the Pal. In either (a) or (b), it is preferable for the originator's mobile terminal to generate a talk indication that is different from the talk-beep normally given as a signal that the floor is open for transmission. This different indication, e.g. a different audible sound or visual indicia or both, informs and reminds the user that the voice message about to be spoken will be for delayed delivery.

In step 208 the mobile terminal determines upon the initiation of the PTT button that a voice message is to be sent for later delivery and sends the spoken information as a series of packets addressed to the destination Pal (Bob or Sue). The header of the packets includes a flag, which is set representing that the voice message being transported by the packets is intended for later delivery. The flag may consist of a bit or byte in a predetermined field of the header that is set to a predetermined value to represent later delivery. In step 210 the originating user releases the PTT button signifying the end of the voice message. This completes the transmission of the voice message intended for later delivery by the originating user.

In step 212 the originating mobile terminal receives an update of the status of the Pals associated with that terminal. As will be explained in further detail below, the communication application server periodically determines the status and transmits updates. Following receipt of the status update, the originating mobile terminal will now display the Pal (Bob or Sue) with additional indicia indicating that a voice message from the originating user is waiting for delivery to the selected Pal. This process terminates at End 216.

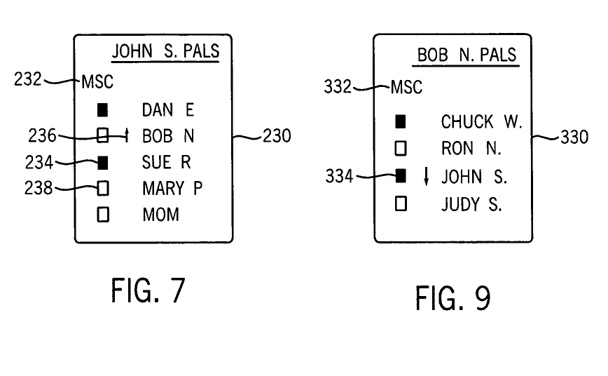

FIG. 7 illustrates an exemplary screen display 230 as seen on the originating user's (John) mobile terminal display following the steps described in FIG. 6. Comparing FIG. 7 with FIG. 5, it will be seen that the display of FIG. 7 in accordance with the present invention includes a message status column (msc) 232. This column provides for the display of indicia for each Pal in a row indicating whether or not a message is waiting for delivery from the user to the corresponding Pal as indicated by a down arrow, or whether a message is waiting for delivery to the user from the corresponding Pal as indicated by an up arrow. A down and up arrow for the same Pal would indicate both a message waiting for delivery to the user from the associated Pal and a message waiting for delivery to the Pal from the user. Assuming that the voice message for later delivery was sent to the recipient Bob, an up arrow 236 in the msc column adjacent the Pal Bob indicates that a message from the user (John S.) has been transmitted and is waiting delivery to Bob. If the voice message for later delivery had been sent to recipient Sue, then an up arrow in the msc column adjacent Sue would be shown to represent the waiting message. It should be noted in FIG. 7 that the status state, the filled-in rectangle 234, for Sue indicates that she is available for communications while the status state 238, an unfilled rectangle, for Mary indicates that she is not available for communications. Even if Sue was available for communications at the time a voice message was sent from John for later delivery to her, the voice message would be stored for later delivery to Sue even though the voice message could have been delivered in substantially real-time to Sue. These steps are followed since it is the originating user that is given priority and control over determining whether a voice message is to be attempted to be delivered in substantially real-time or stored for later delivery.

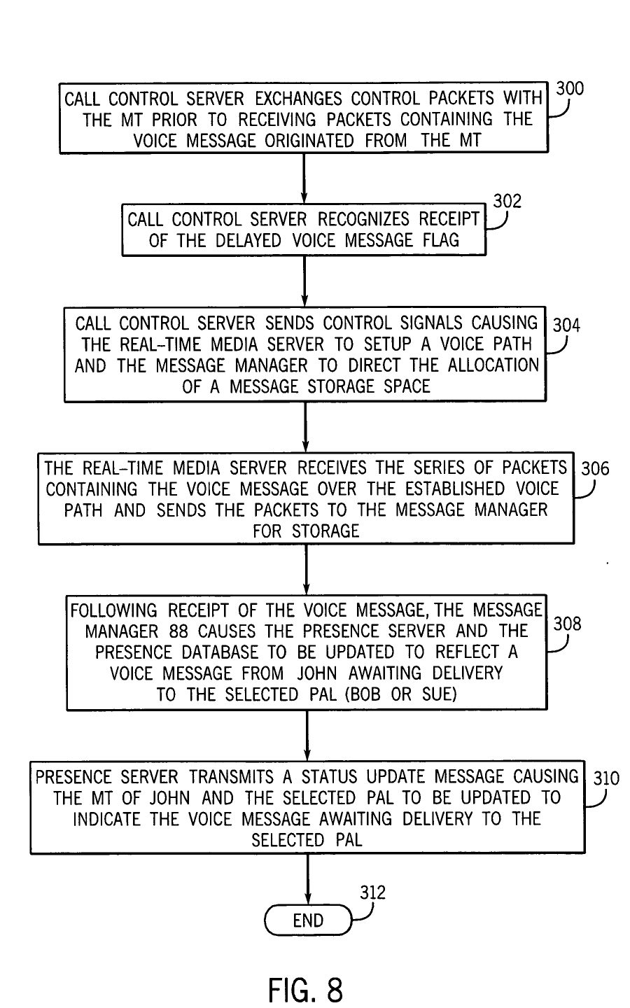

FIG. 8 is a flow diagram illustrating steps taken in accordance with an exemplary method of the present invention by the communication application server 46 in accepting a voice message for later delivery. In step 300 the call control server 84 of communication application server 46 exchanges control packets with John's call initiating mobile terminal at the start of a PTT call prior to any voice packets being transmitted. In step 302 the call control server recognizes that a delayed voice message flag in one of the control packets, such as in the header of one of the control packets. The call control server 84 in step 304 sends control signals causing the real-time media server 86 to set up a voice path and directing the message manager 88 to allocate storage space for the incoming message identified for delayed delivery. In step 306 the real-time media server 86 receives a series of packets containing a voice message over the established voice path and sends the packets containing the voice message to the message manager 88 for storage. Alternatively, the payloads of the packets could be concatenated before being passed to the message manager for storage. Following receipt of the voice message, the message manager 88 causes the presence server 92 and the presence database 90 to be updated to reflect a new voice message from originating user John waiting delivery for the selected Pal (Bob or Sue). In step 310 the presence server 92 transmits a status update message to the originating mobile terminal (John) and the mobile terminal of the selected pal (Bob or Sue) causing the respective mobile terminals to be updated to indicate that a voice message from John is waiting delivery for the selected Pal. This process terminates at End 312.

FIG. 9 is an exemplary screen display 330 of the mobile terminal of destination subscriber Bob following the steps of FIG. 8 having been completed and assuming that the voice message originated from user John is intended for delayed delivery to destination subscriber Pal Bob. The down arrow in the msc column 332 adjacent Pal John indicates that a voice message from John is waiting for delivery to user Bob. In this example status indicator 334 indicates that the originator of the voice message for delayed delivery, John, is still present and available to receive communications. It will be understood that the originator of a voice message intended for delayed delivery may or may not be available for communications at the time that the recipient receives notice of the waiting message. Similarly, the originator of the voice message for delayed delivery may or may not be available for communications at the time the recipient elects to retrieve the waiting message.

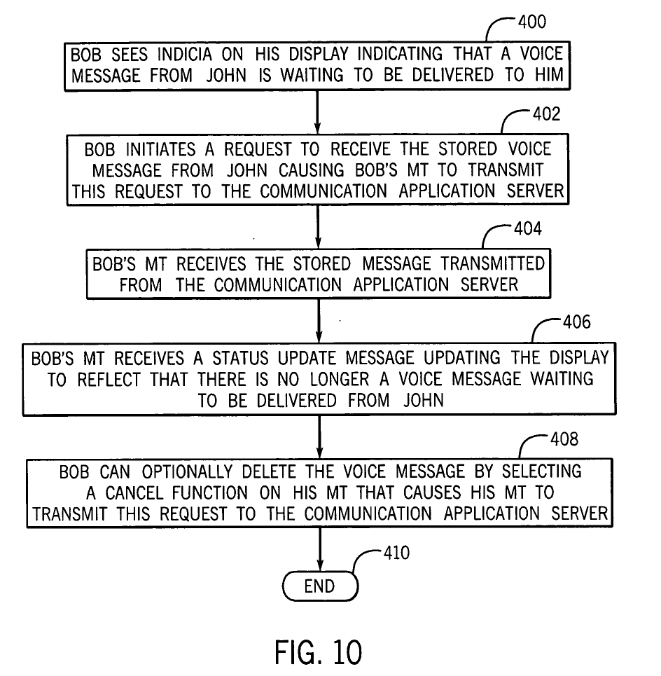

FIG. 10 is a flow diagram illustrating steps by a recipients mobile terminal for retrieving a stored voice message in accordance with an exemplary method of the present invention. In step 400 the recipient Pal, Bob, sees indicia on his screen display indicating that a voice message from John is waiting to be delivered to him. Bob initiates a request to receive the stored voice message from John in step 402. A retrieve message request could for example be accomplished by selecting (highlighting) the Pal that originated the message and further selecting by the use of a function button or indication the desire to retrieve the message (or a particular one of several messages) associated with the selected Pal. In step 404 Bob's mobile terminal receives the stored voice message from John transmitted from the communication application server 46. Following the completion of the delivery of the message, Bob's mobile terminal receives a status update message in step 406 updating his display to reflect that there is no longer a voice message waiting to be delivered from John. Preferably, the status indicator that previously indicated a waiting message will change to a different indicator reflecting that the message has been read by the recipient Pal. This change in status indicator would be transmitted to both the originating and destination users. As indicated in step 408, Bob can optionally delete the voice message as stored at the communication application server 46 by selecting a cancel function on his mobile terminal that will cause his mobile terminal to transmit the cancel request to the communication application server. This process terminates at End 410.

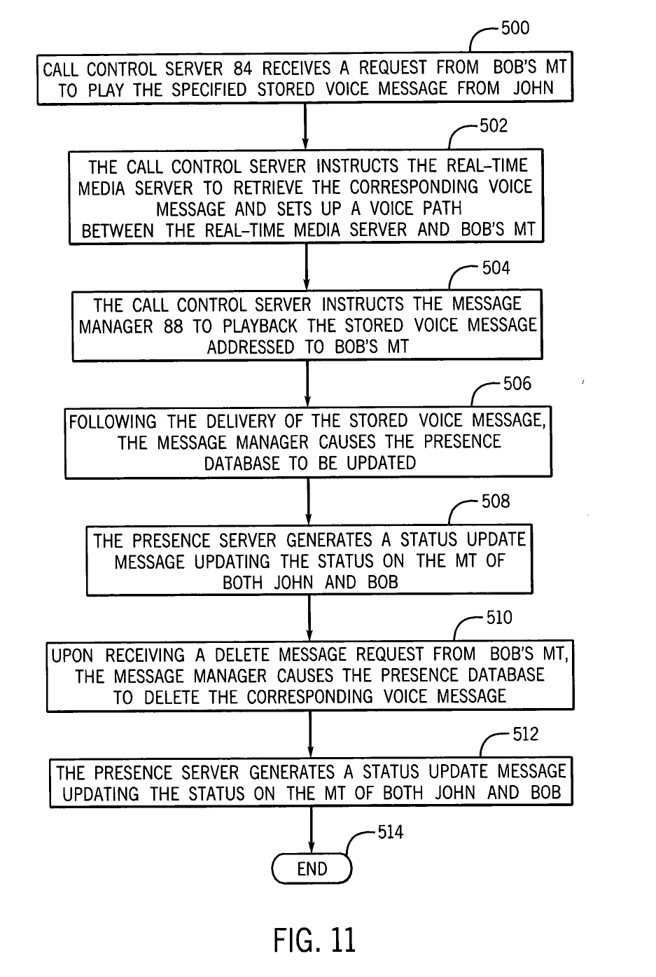

FIG. 11 illustrates steps taken, in accordance with an exemplary method of the present invention, by the communication application server in delivering a stored voice message. In step 500 the call control server 84 receives a request by way of a packet from Bob's mobile terminal to play a specified stored message from Pal John. Since more than one message from John may be waiting for delivery to Bob, it is preferred that the request identify a particular message. In step 502 the call control server 84 sets up a voice path between the message manager 88 and the real-time media server 86, and also a voice path between the real-time media server 86 and the MT. In step 504 the call control server 84 instructs the message manager 88 to begin playback of the voice message. Following the delivery of the stored voice message, in step 506 the message manager 88 causes the presence database to be updated to reflect that the message has been delivered to Bob. The presence server in step 508 generates a status update message updating the status of Pals and messages on the mobile terminal of both John and Bob, and transmits the update message to the mobile terminals of John and Bob. Upon receiving a request from Bob's mobile terminal in step 510 to delete the voice message from John, the message manager 88 causes the presence database 90 to delete the corresponding voice message from John to Bob. In step 512 the presence server 92 generates a status update message updating the status on the mobile terminal of both John and Bob. This causes the indicia representing the read message from John to Bob to be deleted. This process terminates at End 514.

In a further aspect of the embodiment, the originator of a voice message sent for delayed delivery to a destination party maintains a level of access and control of the stored message. Assume that Joe has left a voice message for Susan, and that Susan has not listened to or deleted the message. Joe can utilize his mobile terminal to access and playback the voice message he previously left for Susan. This can be accomplished by selecting an appropriate instruction from a menu on Joe's mobile terminal and causing it to transmit a corresponding command to the communication application server at which the voice message is stored. Since Joe's mobile terminal is recognized as being the originating mobile terminal associated with the stored voice message, and since the recipient (Susan) has not yet retrieved or deleted the message, the communication application server will authenticate the request and proceed to playback the stored voice message to Joe's mobile terminal. Assuming that Susan has not yet retrieved the stored message, Joe also has the option of electing to delete the message prior to Susan having heard it. This can be accomplished by transmitting an instruction from Joe's mobile terminal to the communication application server requesting that the stored voice message to Susan be deleted. Upon receiving this instruction, the communication application server will determine if the subject message has been retrieved by the recipient, and if it has not been retrieved by the recipient and if the request is received from the originating mobile terminal, the request to delete the subject message will be executed. Preferably, this also causes the generation of a status update message to be sent to the respective mobile terminals to reflect that the subject message from Joe to Susan is no longer waiting to be delivered. Only the originator, i.e. the originating mobile terminal, of the stored message can elect to delete a previously sent message for later delivery if the recipient has not yet read and/or deleted the message. This capability is useful in a variety of situations such as where the information in the stored message is now inaccurate or undesired to be communicated in view of changed facts or circumstances.

Various modifications, while remaining within the scope of the present invention, can be made to the above described embodiment. For example, the functions of the different servers and elements that make up the communication application server can be combined and reside in a smaller number of physical elements, or can be further separated to reside in a larger number of physical elements. Also, various functions of the illustrative communication application server can be provided in a different physical location, e.g. outside the communication application server, in a more distributed environment. For improved reliability the communication application server or elements in it can be duplicated for fault tolerance.

In another embodiment the mobile terminals can locally store in memory a voice message intended for later delivery. The operation of this embodiment could be substantially the same as the above described embodiment except that the delayed delivery voice message is stored in the originating mobile terminal instead of in the communication application server. When the destination Pal requests retrieval of the stored voice message, the communication application server would transmit a command to the originating mobile terminal causing it to then transmit the stored voice message to the destination Pal's mobile terminal. Further, various functions supported by the communication application server could be transferred to the mobile terminals assuming that the mobile terminals have sufficient memory and processing power, and that sufficient bandwidth among mobile terminals is available for the extra communications that will result from this distributed architecture. Visual indicia can comprise the display of various words, letters, numbers, symbols, fonts, colors, shading, and the lack of any displayed indicia, i.e. a blank background. Alerts can comprise a change of condition that is humanly perceptible, and more commonly include visual, audible, and the sense of touch.

In a further embodiment the utilization of status indicators are limited in order to minimize bandwidth loading due to messages transmitted by the communication application server to the mobile terminals in order keep the status indicators updated. For example, each mobile terminal affected by a change in status may not be immediately notified of the change. Mobile terminals could be updated with status changes as part of the exchange of control packets at the beginning of a new communication request by a mobile terminal. In another option the mobile terminals would be updated with status changes only at periodic intervals that could vary depending on the overall traffic load of the network. For example, during a busy traffic time when many mobile terminals are engaging in voice communications, status updates could be deferred or limited in the number of mobile terminals being updated in order to maintain sufficient bandwidth to accommodate user communication demands. Since having the correct status of a waiting voice message may be perceived to be of more value than having the correct status of the presence of a Pal, it may be desirable to keep the status of voice messages updated in substantially real-time while the status of the presence of a Pal can be updated on a less frequent basis depending on bandwidth availability.

The lack of having a current status of the presence of a Pal should not have a substantial adverse impact on the embodiments of the present invention. Where a user elects to transmit a delayed delivery voice message to a Pal, the presence status of the Pal will not inhibit the user from proceeding to transmit the delayed delivery voice message. If the user attempts to initiate a real-time communication to a Pal and the user is then advised that the Pal is not available for current communications, again depressing the PTT button for a second time within a predetermined time interval with the same Pal selected will allow the user to automatically generate a delayed delivery voice message. In this situation, the user will not be confused that the voice message being left is for delayed delivery since a unique talk-beep will be played to the user indicating that the voice message to follow will be for delayed delivery. This unique talk-beep signifies a delayed delivery message will result and will be recognized by the user as being different from a normal talk-beep presented to the user prior to being granted the floor to initiate a voice transmission during a real-time communication.

1. A method implemented by a push-to-talk wireless mobile terminal for communicating voice information comprising the steps of:
determining if a request to send a delayed delivery voice message has been made;
if said determining step determines that a request to send a delayed delivery voice message has been made, transmitting an indicator to a communication application server representing an instruction that packets received from the mobile terminal are to be stored for later delivery to a destination Pal;
encoding audio input from a user by the mobile terminal into the packets following the determining step;
transmitting the packets to the communication application server for later delivery to the destination Pal.

2. The method of claim 1 wherein the step of determining if a request to send a delayed delivery voice message has been made comprises sensing that the destination Pal selected by the user to receive the audio input is not available prior to the user initiating the encoding step.

3. The method of claim 2 wherein the step of sensing that the Pal selected by the user as the destination party to receive the audio input is not available comprises the step of determining a current status of the selected Pal stored in the mobile terminal, where the status represents that the selected Pal is not available to receive communications.

4. The method of claim 1 wherein the step of determining if a request to send a delayed delivery voice message has been made comprises determining that an input signal is entered by the user where the input signal represents a request to send said packets as a delayed delivery voice message regardless of whether or not the destination Pal selected to receive the packets is currently available to receive communications.

5. The method of claim 1 wherein the step of transmitting an indicator to a communication application server representing an instruction that the packets are to be stored for later delivery to a destination Pal causes the audio carried by the packets to be stored in the communication application server.

6. The method of claim 5 wherein the instruction further conveys to the communication application server that the packets are not to be attempted to be delivered in real-time to the destination Pal.

7. The method of claim 1 wherein the step of determining if a request to send a delayed delivery voice message has been made comprises the steps of generating a first request for a real-time voice communication to the destination Pal in response to the push-to-talk button being pressed, providing a first alert to the user indicating that a real-time voice communication to the destination Pal is not available, and sensing a second request to initiate communications to the destination Pal by the push-to-talk button being depressed again following the alert having been provided to the user.

8. The method of claim 7 wherein the step of sensing the second request includes sensing the push-to-talk button being depressed again within a predetermined time interval of the first request.

9. The method of claim 7 further comprising the step of providing a second alert to the user in response to the second request wherein the second alert comprises a predetermined talk-beep associated with the request to send a delayed delivery voice message, the predetermined talk-beep comprising an audible alert that is different from an audible alert associated with the initiation of a real-time voice communication.

10. A push-to-talk wireless mobile terminal for communicating voice information comprising:
means for determining if a request to send a delayed delivery voice message has been made;
means for transmitting an indicator to a communication application server representing an instruction that packets received from the mobile terminal are to be stored for later delivery to a destination Pal if said determining means determines that a request to send a delayed delivery voice message has been made;
means for encoding audio input from a user by the mobile terminal into the packets following the determining step;
means for transmitting the packets to the communication application server for later delivery to the destination Pal.

11. The mobile terminal of claim 10 wherein the means for determining comprises means for sensing that the destination Pal selected by the user to receive the audio input is not available to receive real-time communications.

12. The mobile terminal of claim 11 wherein the means for sensing comprises means for determining a current status of the selected Pal stored in the mobile terminal, where the status represents that the selected Pal is not available to receive communications.

13. The mobile terminal of claim 10 wherein the means for determining if a request to send a delayed delivery voice message has been made comprises means for determining that an input signal is entered by the user where the input signal represents a request to send said packets as a delayed delivery voice message regardless of whether or not the destination Pal selected to receive the packets is currently available to receive communications.

14. The mobile terminal of claim 10 wherein the means for transmitting an indicator to a communication application server representing an instruction that the packets are to be stored for later delivery to a destination Pal causes the audio carried by the packets to be stored in the communication application server.

15. The mobile terminal of claim 14 wherein the instruction transmitted by the means for transmitting further conveys to the communication application server that the packets are not to be attempted to be delivered in real-time to the destination Pal.

16. The mobile terminal of claim 10 wherein the means for determining if a request to send a delayed delivery voice message has been made comprises means for generating a first request for a real-time voice communication to the destination Pal in response to the push-to-talk button being pressed, means for providing a first alert to the user indicating that a real-time voice communication to the destination Pal is not available, and means for sensing a second request to initiate communications to the destination Pal by the push-to-talk button being depressed again following the alert having been provided to the user.

17. The mobile terminal of claim 16 wherein the means for sensing the second request includes means for sensing the push-to-talk button being depressed again within a predetermined time interval of the first request.

18. The mobile terminal of claim 16 further comprising means for providing a second alert to the user in response to the second request, the second alert comprises a predetermined talk-beep associated with the request to send a delayed delivery voice message, the predetermined talk-beep comprising an audible alert that is different from an audible alert associated with the initiation of a real-time voice communication.

19. A method implemented by a push-to-talk wireless mobile terminal for communicating voice information comprising the steps of:
displaying a list of Pals of the first user including visual indicia representing that a previously transmitted voice message by the first user to a first Pal is stored and awaits delivery to the first Pal;
determining if a request has been made by the first user to access the stored voice message;
if said request is determined to have been made, discerning the type of access desired by the first user;
transmitting a command to a communication application server at which the voice messages stored where the command conveys instructions to the communication application server to implement action based on the type of access desired by the first user.

20. The method of claim 19 wherein the step of discerning comprises discerning that the stored voice message is to be played back to the first user and wherein the transmitted command conveys instructions to the communication application server to implement transmission of the stored voice message to the first user, the method further comprising the step of receiving at the mobile terminal of the first user the stored voice message previously transmitted by the first user to the first Pal and audibly playing the stored voice message.

21. The method of claim 19 wherein the step of discerning comprises discerning that the stored voice message is to be deleted and wherein the transmitted command conveys instructions to the communication application server to delete the stored voice message previously transmitted by the first user to the first Pal, the method further comprising the step of receiving at the mobile terminal of the first user a signal technology that the stored voice message has been deleted.

22. A push-to-talk wireless mobile terminal for communicating voice information comprising:
means for displaying a list of Pals of the first user including visual indicia representing that a previously transmitted voice message by the first user to a first Pal is stored and awaits delivery to the first Pal;
means for determining if a request has been made by the first user to access the stored voice message;
means for discerning the type of access desired by the first user if said request is determined to have been made;
means for transmitting a command to a communication application server at which the voice messages are stored where the command conveys instructions to the communication application server to implement action based on the type of access desired by the first user.

23. The mobile terminal of claim 22 wherein the means for discerning discerns that the stored voice message is to be played back to the first user and wherein the means for transmitting transmits the command that conveys instructions to the communication application server to implement transmission of the stored voice message to the first user, the mobile terminal further comprising means for receiving, at the mobile terminal of the first user, the stored voice message previously transmitted by the first user to the first Pal and audibly playing the stored voice message.

24. The mobile terminal of claim 22 wherein the means for discerning discerns that the stored voice message is to be deleted and wherein the means for transmitting transmits the command that conveys instructions to the communication application server to delete the stored voice message previously transmitted by the first user to the first Pal, the mobile terminal further comprising means for receiving at the mobile terminal of the first user a signal representing that the stored voice message has been deleted.

25. A method implemented by a push-to-talk wireless mobile terminal for communicating voice information comprising the steps of:
displaying a list of Pals including visual indicia of whether a voice message is waiting for delivery from a Pal;
determining if a request to receive a waiting voice message has been initiated by a user of the mobile terminal;
if said request is determined to have been made, transmitting at least one packet to a communication application server requesting that the waiting voice message associated with a selected Pal be delivered to the user's mobile terminal;
receiving packets at the user's mobile terminal from the communication application server containing the waiting voice message and playing the message to the user.

26. The method of claim 25 wherein the steps of determining if the request has been made comprises sensing that a Pal is selected by the user where the Pal has corresponding visual indicia indicating that a voice message from the Pal is waiting delivery to the user, and sensing an input initiated by the user representing a request to receive delivery of the voice message corresponding to the selected Pal.

27. The method of claim 26 further comprising the steps of receiving a status update following receiving the packets where the status update indicates that there is no longer the voice message from the Pal waiting delivery to the user and updating the visual indicia corresponding to the Pal whose voice message was received to show another visual indicia representing that the voice message is no longer waiting delivery to the user.

28. A push-to-talk wireless mobile terminal for communicating voice information comprising:
means for displaying a list of Pals including visual indicia of whether a voice message is waiting for delivery from a Pal;
means for determining if a request to receive a waiting voice message has been initiated by a user of the mobile terminal;
means for transmitting at least one packet to a communication application server requesting that the waiting voice message associated with a selected Pal be delivered to the user's mobile terminal if said request is determined to have been made;
means for receiving packets at the user's mobile terminal from the communication application server containing the waiting voice message and playing the message to the user.

29. The mobile terminal of claim 28 wherein the means for determining if the request has been made comprises means for sensing that a Pal is selected by the user where the Pal has corresponding visual indicia indicating that a voice message from the Pal is waiting delivery to the user, and means for sensing an input initiated by the user representing a request to receive delivery of the voice message corresponding to the selected Pal.

30. The mobile terminal of claim 29 further comprising means for receiving a status update following receiving the packets where the status update indicates that there is no longer the voice message from the Pal waiting delivery to the user and means for updating the visual indicia corresponding to the Pal whose voice message was received to show another visual indicia representing that the voice message is no longer waiting delivery to the user.

31. A method implemented by a communication application server in a packet communication network for processing communications comprising the steps of:
receiving a first packet from a mobile terminal of a user;
determining if the first packet contains an indicator representing an instruction to process any following voice packets as a delayed delivery voice message;
receiving a set of voice packets from a mobile terminal of a user;
if said determining step determines that said indicator is present, storing at least payloads of the voice packets of said set in memory and labeling the stored payloads as addressed to a destination Pal identified by said set of packets.

32. The method of claim 31 further comprising the step of attempting to deliver voice information contained in said payloads only upon receiving a command from a mobile terminal of the destination Pal where the command corresponds to input initiated by the Pal to retrieve the stored voice information.

32. The method of claim 31 further comprising the steps of generating a status update following the storing step and transmitting the status update to at least the mobile terminals of the destination Pal and the user.

33. The method of claim 32 wherein the step of transmitting the status update comprises transmitting a status update to the destination Pal indicating that the voice information from the user is awaiting deliver to the destination Pal and transmitting a status update to the user indicating that the voice information from the user to the destination Pal is still awaiting delivery to the destination Pal.

34. The method of claim 32 further comprising the step of receiving said command from the mobile terminal of the destination Pal, retrieving the at least voice information payloads, encoding the at least voice information payloads into further packets addressed to the destination Pal, and transmitting the further packets to the destination Pal.

35. The method of claim 34 further comprising the steps of generating a status update following the transmitting of the further packets and transmitting the status update to at least the mobile terminals of the destination Pal and the user, where the status update represents that the voice information has been delivered to the destination Pal.

36. The method of claim 35 wherein the step of transmitting the status update comprises transmitting a status update to the destination Pal indicating that there is no longer the voice information from the user awaiting deliver to the destination Pal and transmitting a status update to the user indicating that there is no longer the voice information from the user awaiting delivery to the destination Pal.

37. A communication application server in a packet communication network for processing communications comprising:
means for receiving a first packet from a mobile terminal of a user;
means for determining if the first packet contains an indicator representing an instruction to process any following voice packets as a delayed delivery voice message;
means for receiving a set of voice packets from a mobile terminal of a user;
means for storing at least payloads of the voice packets of said set in memory and labeling the stored payloads as addressed to a destination Pal identified by said set of packets if said determining step determines that said indicator is present.

38. The communication application server of claim 37 further comprising means for attempting to deliver voice information contained in said payloads only upon receiving a command from a mobile terminal of the destination Pal where the command corresponds to input initiated by the Pal to retrieve the stored voice information.

39. The communication application server of claim 37 further comprising means for generating a status update following the storage of the at least payloads and means for transmitting the status update to at least the mobile terminals of the destination Pal and the user.

40. The communication application server of claim 39 wherein the means for transmitting the status update comprises means for transmitting a status update to the destination Pal indicating that the voice information from the user is awaiting delivery to the destination Pal and means for transmitting a status update to the user indicating that the voice information from the user to the destination Pal is still awaiting delivery to the destination Pal.

41. The communication application server of claim 39 further comprising means for receiving said command from the mobile terminal of the destination Pal, means for retrieving the at least voice information payloads, means for encoding the at least voice information payloads into further packets addressed to the destination Pal, and means for transmitting the further packets to the destination Pal.

42. The communication application server of claim 41 further comprising means for generating a status update following the transmitting of the further packets and means for transmitting the status update to at least the mobile terminals of the destination Pal and the user, where the status update represents that the voice information has been delivered to the destination Pal.

43. The communication application server of claim 42 wherein the means for transmitting the status update comprises means for transmitting a status update to the destination Pal indicating that there is no longer the voice information from the user awaiting deliver to the destination Pal and means for transmitting a status update to the user indicating that there is no longer the voice information from the user awaiting delivery to the destination Pal.
